(19) United States
(12) Patent Application Publication
(10) Pub. No.: US 2013/0252571 A1
(43) Pub. Date: Sep. 26, 2013

(54) SPEECH RECOGNITION BASED EMERGENCY SITUATION ALERT SERVICE IN MOBILE TERMINAL

(71) Applicant: SAMSUNG ELECTRONICS CO., LTD., Gyeonggi-do (KR)

(72) Inventor: Jungeun LEE, Gyeongbuk (KR)

(73) Assignee: Samsung Electronics Co., Ltd., Gyeonggi-do (KR)

(21) Appl. No.: 13/847,119

(22) Filed: Mar. 19, 2013

(30) Foreign Application Priority Data
Mar. 20, 2012 (KR) 10-2012-0028099

(51) Int. Cl. H04W 4/22

(52) U.S. Cl. CPC H04W 4/22
USPC 455/404.1

(57) ABSTRACT

A method and apparatus of detecting and reporting an emergency situation of a mobile terminal user to a third party using an audio recognition function included in a mobile terminal are provided. The method includes recognizing speech received from a microphone; determining whether a current situation is emergent based on the recognized speech; and controlling a radio frequency communication unit to report the emergency situation to a preset external device when the current situation is emergent.

### CLAIM OF PRIORITY

This application claims the benefit under 35 U.S.C. §119(a) of a Korean patent application filed on Mar. 20, 2012 in the Korean Intellectual Property Office and assigned Serial No. 10-2012-0028099, the entire disclosure of which is hereby incorporated by reference.

### BACKGROUND

1. Technical Field

The present disclosure relates generally to mobile communication terminals and more particularly, to a method for handling an emergency situation employing a mobile terminal.

2. Description of the Related Art

In recent years, with the significant advances of information, communication and semiconductor technologies, the supply and use of all types of mobile terminals including cell phones, smart phones, tablet PCs, etc., have rapidly increased. In particular, recent mobile terminals have developed to a mobile convergence stage in which numerous functions and services beyond the traditional calling function are now performed.

The mobile terminal may have an SOS function in which an emergency SOS message is transmitted to another designated mobile terminal, e.g., as Short Message Service (SMS) message. The SOS message is transmitted when a user continuously presses a specific key of the mobile terminal multiple times (e.g., four times) to report a user's emergency situation to third parties. Accordingly, to activate the SOS function of the related art, a user in an emergency situation directly operates a terminal to report an emergency situation to others. However, under certain emergency conditions, it may be difficult or impossible for the user to do so. For example, if a home is invaded or if a person is assaulted in a dark environment, immediate access to the mobile terminal to initiate the SOS commands may not be possible.

### SUMMARY

The present disclosure provides a way to report a user's emergency situation to a third party using an audio recognition function included in a mobile terminal.

The present disclosure further provides a method and apparatus for recording an emergency situation and using the recorded emergency situation as evidence data with respect to the emergency situation.

In accordance with an aspect, a method of detecting an emergency situation and reporting the emergency to a third party is performed in a mobile terminal having a speech recognition function. Speech received from a microphone is recognized. It is then determined whether a current situation is emergent based on the recognized speech. When an emergency is detected, it is reported via a radio frequency communication unit to a preset external device. Automatic recording and transmission thereof may be performed for a predetermined time interval in some embodiments.

In accordance with another aspect, a mobile terminal includes: a microphone; an audio processor converting speech input from the microphone into speech data; a radio frequency communication unit transmitting information associated with the speech data to an external device; and a controller recognizing the speech data from the audio processor, determining whether a current situation is emergent based on the recognition information, and controlling the radio frequency unit to report an emergency situation to the external device when the current situation is emergent.

### BRIEF DESCRIPTION OF THE DRAWINGS

The aspects, features and advantages of the present invention will be more apparent from the following detailed description in conjunction with the accompanying drawings, in which:

FIG. 1 is a block diagram illustrating a configuration of a mobile terminal according to an exemplary embodiment of the present invention;

FIG. 2 is a block diagram illustrating a configuration of a controller according to an exemplary embodiment of the present invention;

FIG. 3 is a flowchart illustrating environment setting of an emergency situation alert service according to an exemplary embodiment of the present invention;

FIG. 4 shows example screens for setting an environment of a mobile terminal according to an exemplary embodiment of the present invention;

FIG. 5 is a flowchart illustrating a method of recognizing a speech inputted from a microphone in a mobile terminal to provide an emergency situation alert service according to an exemplary embodiment of the present invention;

FIG. 6 is a flowchart illustrating a method of reporting an emergency situation alert according to an exemplary embodiment of the present invention;

FIG. 7 is a flowchart illustrating a method of reporting an emergency situation alert according to another exemplary embodiment of the present invention;

FIG. 8 is a flowchart illustrating a method of reporting an emergency situation alert according to still another exemplary embodiment of the present invention; and

FIG. 9 is a flowchart illustrating a method of reporting an emergency situation alert according to yet another exemplary embodiment of the present invention.

### DETAILED DESCRIPTION OF EXEMPLARY EMBODIMENTS

A method and apparatus for detecting and reporting an emergency situation in a mobile terminal according to exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

A mobile terminal according to the present invention may include a configuration which recognizes speech from audio data input from a microphone, analyzes the recognized speech, and provides an emergency situation alert service to the user according to the analysis result. For example, the emergency situation alert service may be a service which records speech and transmits a recorded speech file to a designated external device. The alert service may automatically request connection of a call (e.g., voice call or video call) to the designated external device. In addition, the emergency situation alert service may be configured to output an emergency situation alarm sound through a speaker with a maximum output.

Herein, the terms “emergent” and “an emergency” are used interchangeably. When a situation is deemed to be emergent, this is indicative of an emergency, which warrants the issuance of an alert to a third party external device.

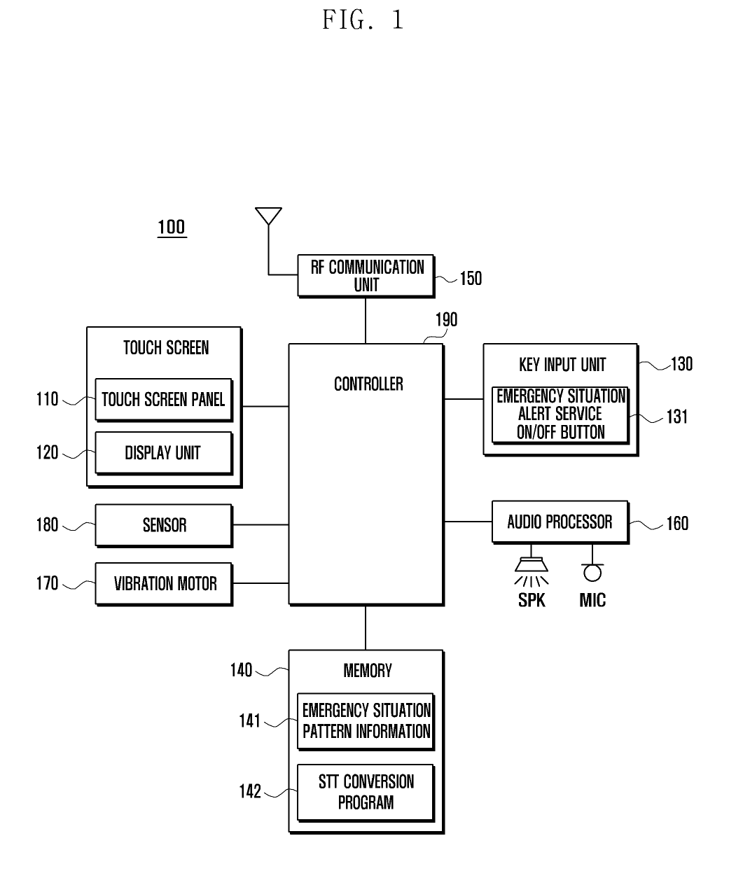

FIG. 1 is a block diagram illustrating a configuration of a mobile terminal, 100, according to an exemplary embodiment of the present invention. Mobile terminal 100 may include a touch screen having a touch screen panel 110 and a display unit 120, a key input unit 130, a memory 140, a radio frequency (RF) communication unit 150, an audio processor 160, a speaker SPK, a microphone MIC, a vibration motor 170, a sensor 180, and a controller 190.

The touch screen panel 110 may be integrated with the display unit 120, and generates and transfers a signal (e.g., touch event) to the controller 190 in response to a user gesture input to the touch screen panel 110. The controller 190 may detect a user gesture from a touch event received from the touch screen panel 110 to control the foregoing constituent elements. The user gesture may be classified into a touch and a tough gesture. Here, the touch gesture may include tap, double tap, long tap, drag, drag & drop, and flick. Here, the touch is an operation where a user contacts one point of a screen using a touch means (e.g., finger or stylus pen). A tap is an operation where the user releases the touch means in a corresponding point without a motion of the touch means after touching one point. A double tap is an operation where a user consecutively taps one point twice. A long tap is an operation where a finger is released from a corresponding point without a motion of the touch means after touching one point for a duration longer than the tap. A drag is an operation that moves the touch means across the screen surface while touch contact is maintained. A drag & drop is an operation that releases a touch means over a displayed second object after a drag in order to “drop” a first object therein. A flick is an operation that releases a touch means after moving at high speed like flipping. A touch signifies a state contacted on the touch screen, and a touch gesture signifies a continuous motion from an initial touch to a release.

A resistive type, a capacitive type, and an electromagnetic induction type are applicable to the touch screen panel 110.

Although not shown, the touch screen panel 110 includes a controller. The controller receives a touch event from the touch screen panel 110, and analog to digital (AD)-converts and transfers the received touch event to the controller 190. The controller 190 detects a touch gesture from the transferred touch event. That is, the controller 190 may detect a touched point, a moving distance of touch, a motion direction of the touch, and speed of the touch. The controller may be mechanically located between the touch screen panel 110 and the controller 190, or be provided inside the controller 190.

The display unit 120 converts image data inputted from the controller 190 into an analog signal, and displays the analog signal under the control of the controller 190. That is, the display unit 112 may provide various screens according to use of the portable terminal, for example, a lock screen, a home screen, an application (hereinafter referred to as ‘App’) execution screen, a menu screen, a keypad screen, a message creation screen, and an Internet screen. A lock screen presents an image displayed when the terminal is in a “locked” state. When a specific touch event for releasing the locking occurs, the controller 190 may convert the displayed image from a lock screen into a home screen or an App execution screen. The home screen may be defined as an image including a plurality of App icons corresponding to a plurality of Apps, respectively. When one is selected from a plurality of App icons by a user, the controller 190 may execute a corresponding App, for example, an electronic book App and convert the home screen into an execution screen.

The display unit 120 may be configured in the form of a flat panel display such as a Liquid Crystal Display (LCD), an Organic Light Emitted Diode (OLED), and an Active Matrix Organic Light Emitted Diode (AMOLED).

The key input unit 130 may include a plurality of input keys and function keys for receiving numeric or character information and setting various functions. The function keys may include arrow keys, side keys, and hot keys set such that a specific function is performed.

The key input unit 130 generates and transfers a key signal associated with user setting and function control of the mobile terminal 100 to the controller 190. The key signal may be classified into an on/off signal, a volume control signal, and a screen on/off signal. The controller 190 controls the foregoing constituent elements in response to the key signal. The key input unit 130 may include a QWERTY keypad, a 3*4 keypad, a 4*3 keypad having a plurality of keys.

When the touch panel 110 of the portable terminal is supported in the form of a full touch screen, the key input unit 130 may include only at least one side key for screen on/off and portable terminal on/off, which is provided in a side of a case of the mobile terminal 100.

The key input unit 130 may include a service on/off button 131 for setting the activation of an emergency situation alert service as a dedicated button. The service on/off button 131 may be a non-dedicated button. For example, the dedicated button could be the volume key, which when pressed a predetermined number of successive times, causes activation of the alert service. For instance, if the user presses a volume key four times, the controller 190 may detect the input information and activate the emergency situation alert service. A user might selectively activate the service when she senses a probability of danger, e.g., prior to entering a perceived dangerous setting, or prior to sleeping alone. Alternatively, she may activate the service at all times. The alert service activation may be designed to be terminated with the same or similar key sequence as that used to activate it, or with a different key/sequence. In certain embodiments, the alert service can be activated by selecting a virtual key or a dedicated icon on the touch screen. In another variant, the alert service may be automatically activated at a preset time. For example, a setting may allow the alert service to be automatically activated from midnight to six a.m., where the setting may be for a single night, or on a daily basis. When the alert service use is not necessary, the automatic activation function may be turned-off by the user.

The memory 140 may store an Operating System (OS) of the portable terminal, an App and various data used in embodiments of the present invention. The memory 140 may primarily include a data region and a program area.

The data area of the memory 140 may store data, namely, a contact point, an image, a document, video, messages, mail, music, a sound effect generated from the mobile terminal 100 or downloaded from an external source according to use of the mobile terminal 100. The data area may store the screen data for screens the display unit 112 displays. The menu screen may include a screen switch key (e.g., a return key for returning to a previous screen) for switching the screen and a control key for controlling a currently executed App. The data area may store data which the user copies from messages, photographs, web pages, or documents for copy & paste.

The data area of the memory 140 may store various preset values (e.g., screen brightness, vibration during the occurrence of touch, automatic rotation of a screen) for operating the mobile terminal. Particularly, the data area may store various preset values (e.g., recording time, a phone number of mobile terminal to which a message is transmitted, presence of automatic performing of an emergency situation alert service, SOS scheme) for setting an environment of the emergency situation alert service. The data area of the memory 140 may store emergency situation pattern information 141 with which the controller 190 compares recognized speech information.

The emergency situation pattern information 141 may include speech characteristic information (e.g., tone, frequency, etc.) associated with characteristics of a speech. That is, the speech characteristic information may be used as information for determining whether the recognized speech is a speech of a specific person. Here, the specific person may be a user or family as a person set by the user. The controller 190 detects speech characteristic information from speech data input from the audio processor 160, and stores the detected speech characteristic information as the emergency situation pattern information 141.

The emergency situation pattern information 141 may include word information, i.e., information for determining whether contents of the recognized speech are a specific word. The specific word may be information stored in the memory 140 by the user, for example, “help”. The controller 190 converts speech data input from the audio processor 160 into a text, and compares the converted text with the word information to determine the emergency situation. Pattern information for phrases, screeches, etc. may be similarly stored and compared.

The emergency situation pattern information 141 may include magnitude information, for example, decibel information of a sound. The decibel information may be information set by the user, for example, 90 dB. The controller 190 detects decibel information from speech data input from the audio processor 160. When the detected decibel is greater than the set decibel, the controller 190 may determine a current situation as an emergent situation.

The program area of the memory 140 may store an Operating System (OS) and various Apps for booting the portable terminal and operating the foregoing constituent elements. In detail, the program area may store a web browser for accessing an Internet, an MP3 player for playing a sound source, and a camera App for capturing, displaying, and storing a subject image. In particular, the program area may store a Speech To Text (STT) conversion program 142 converting speech data into a text.

The RF communication unit 150 performs speech call, video call, or data communication under the control of the controller 190. For these functions, the RF communication unit 150 may include an RF transmitter for up-converting a frequency of a transmitted signal and amplifying the converted signal, and an RF receiver for low-noise-amplifying a frequency of a received signal and down-converting the amplified signal. Any of a number of communication protocols can be used to convey normal communication signals, as well as the RF signals of the emergency alert service. For instance, the RF communication unit 150 may include a mobile communication module (e.g., 3^{rd}-generation mobile communication module, 3.5-generation mobile communication module, 4^{th}- or 5^{th}-generation mobile communication module, etc.), and a digital broadcasting module (e.g., DMB module). The RF communication unit 150 may further include a near field communication module. The near field communication module performs a function of connecting the mobile terminal 100 to an external device in a wired or wireless scheme. The near field communication module may include a Zigbee module, a Wi-Fi module, or a Bluetooth module.

To process output sound, the audio processor 160 receives audio data such as a speech from the controller 190, D/A-converts the received audio data into an analog signal, and outputs the analog signal to the SPK. To process audio input, audio processor 160 A/D-converts an audio input such as a speech input from the microphone MIC into a digital signal (also referred to herein as speech data) and transfers the digital signal to the controller 190. Particularly, the audio processor 160 according to the present invention may provide feedback (e.g., sound effect or speech) associated with activation or termination of the emergency situation alert service through the speaker under control of the controller 190. For example, if a service on/off button 131 is pressed, a speech including “emergency situation alert service starts” may be outputted. If the service on/off button 13 is again pressed, a speech including “emergency situation alert service is terminated” may be outputted.

The vibration motor 170 performs vibration under a control of the controller 190. Particularly, the vibration motor 170 in certain embodiments of the present invention provides feedback associated with activation or termination of the emergency situation alert service under the control of the controller 190. That is, when the emergency situation alert service is activated or terminated, the vibration motor 170 may be designed to vibrate.

The sensor 180 may detect at least one of various changes such as orientation variation (using a gyroscope), illumination variation, and acceleration variation of the mobile terminal 100, and transfers an electric signal indicative of the changes to the controller 190.

The controller 190 may control internal operations of the mobile terminal in response to the detection information input from the sensor 180. For example, the controller 170 may detect a display mode of the mobile terminal 100 as one of a landscape mode and a portrait mode based on the detected orientation information.

The controller 190 performs a function of controlling an overall operation of the mobile terminal 100 and signal flow between internal constituent elements of the mobile terminal 100, and processing data. The controller 190 controls power supply from a battery to internal constituent elements. The controller 190 executes various applications stored in the program area.

When an emergency situation alert service is in an activation mode, the controller 190 drives a microphone MIC. The audio processor 160 transfers audio data such as the speech input from the microphone MIC to the controller 190.

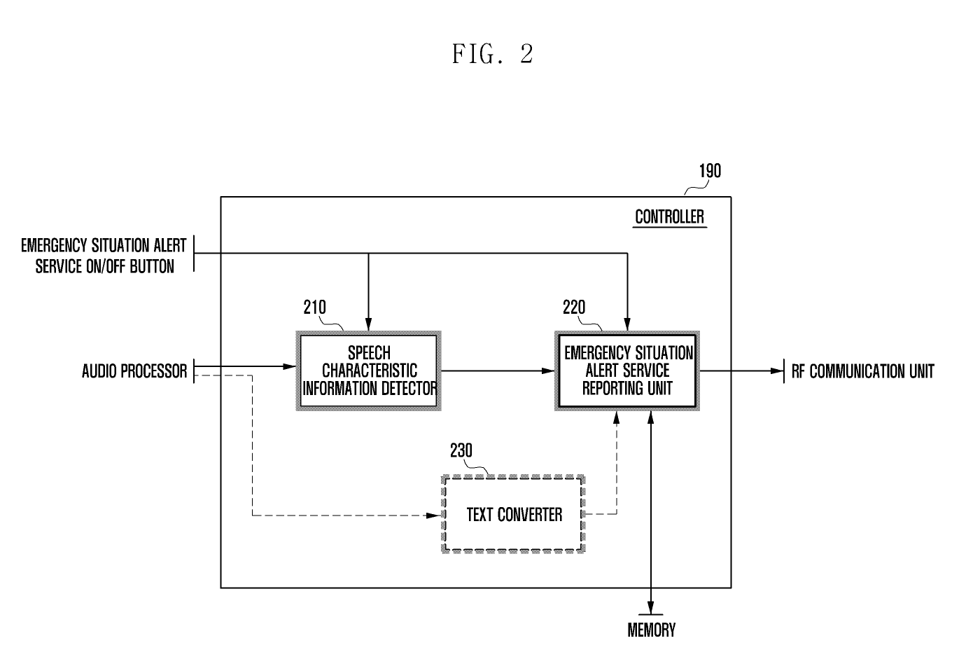

The controller 190 may include constituent elements as shown in FIG. 2 which recognizes speech from the audio data, analyzes the recognized speech, and provides the emergency situation alert service to the user according to the analysis result.

FIG. 2 is a block diagram illustrating a configuration of a controller according to an exemplary embodiment of the present invention. As shown, controller 190 may include a speech characteristic information detector (hereinafter referred to as “detector”) 210 and an emergency situation alert service reporting unit (hereinafter referred to as “reporting unit”) 220.

The detector 210 receives audio data from the audio processor 160. Detector 210 detects speech characteristic information (e.g., tone, frequency, decibel) associated with characteristics of speech from the received audio data.

The reporting unit 220 compares the detected speech characteristic information with the emergency situation pattern information 141 stored in the memory 140. Reporting unit 220 determines whether a current situation is emergent based on the comparison result. Some examples of pre-designated emergent situations determinable by the reporting unit 220 are: i) the magnitude of the received speech is greater than a preset decibel; ii) the received speech is associated with a specific word (e.g., “help”); or, iii) the received speech is that of a person for which no setting has been established (i.e., speech of a person unknown to the user).

When the current situation is deemed emergent, the reporting unit 220 may record the received speech in a preset time unit (e.g., for 3 minutes). The reporting unit 220 may control the RF communication unit 150 to transmit a file thus recorded for three minutes to a designated external device. For example, the record file and the transmitted record file may be later used as evidence of a criminal incident.

When the current situation is emergent, the reporting unit 220 may automatically initiate a call (speech or video call) connection to a designated external device. Accordingly, a third party user, that is, a receiver of the external device, is alerted of an emergency situation associated with the mobile terminal 100 by reproducing a received record file or by answering the call. In certain embodiments, the alert reporting the emergency can additionally or alternatively be sent to the third party external device as a text message.

Meanwhile, the controller 190 may further include a text converter 230 converting the received speech data into a text and transferring the converted text to the service providing unit 220. The reporting unit 220 may compare the transferred text with emergency situation pattern information 141, that is, character characteristic information stored in the memory 140 to determine the emergency situation.

In recent years, speech recognition technology has rapidly been developed. As described above, in addition to a technique of converting speech into text or detecting speech characteristic information such as tone or frequency from the speech, techniques exist for recognizing a specific keyword (e.g., help) or a context (meaning of sentence) in speech. Accordingly, embodiments of the present invention may include various other configurations for providing an emergency situation alert service. For instance, the controller 190 may include a context recognizer recognizing a context of received speech data. The context recognizer may recognize an emergency situation as a recognition result of “Oh, come on, please. Don't do this to me”, and in response may execute the emergency situation alert service.

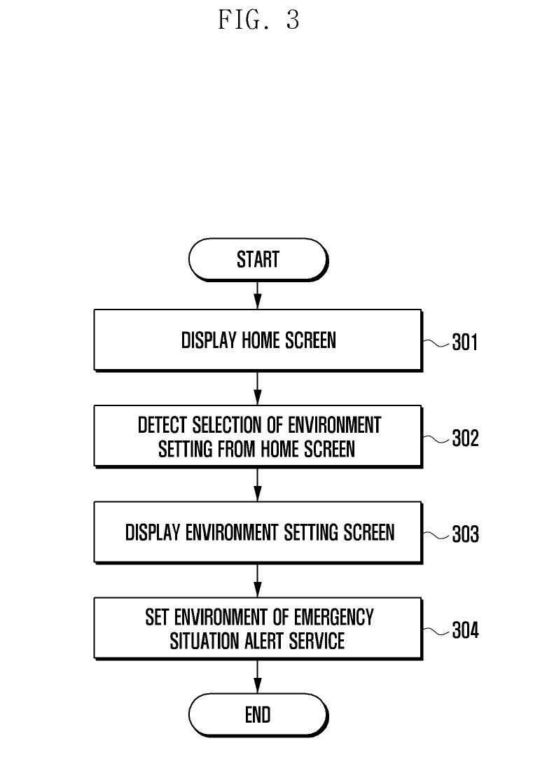

FIG. 3 is a flowchart illustrating environment setting of an emergency situation alert service according to an exemplary embodiment of the present invention. The controller 190 may first control display unit 120 to display a home screen (301). The home screen includes an icon corresponding to environment setting. A user may touch the icon (302) whereby the controller 190 detects user selection of the icon corresponding to the environment setting from the home screen (302). The controller 190 then controls a display unit 120 to display an environment setting screen for setting an alert condition environment of the mobile terminal 100 (303). The controller 190 sets an environment of the emergency situation alert service (304). That is, in a displayed state of the environment setting screen, the user may operate a touch screen panel 110 to set an alert condition environment of the mobile terminal, particularly, an environment of the emergency situation alert service. The set information is stored in the memory 140 of the mobile terminal. The set information stored in the memory 140 may be used when the emergency situation alert service is activated.

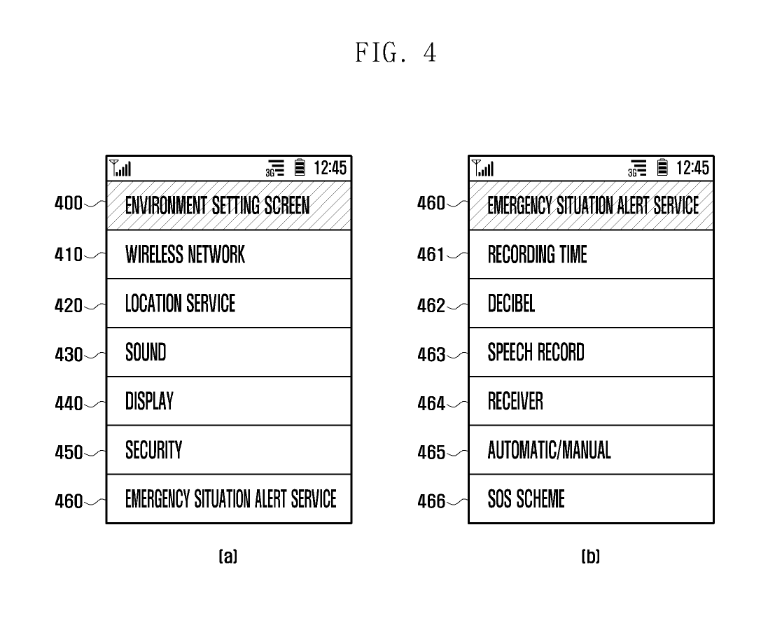

FIG. 4 shows example screens for setting an environment of a mobile terminal according to an exemplary embodiment of the present invention. Referring to example screen (a), the controller 120 may display an environment setting screen 400. Various items are included in the environment setting screen 400 according to performance capability and functions of the mobile terminal 100. For example, the environment setting screen 400 may include items such as a wireless network 410, a location service 420, a sound 430, a display 440, a security 450, and an emergency situation alert service 460. The user may select the alert service menu item 460 via touch input. Then, the controller 190 controls the display unit 120 to display an environment setting screen of the emergency situation alert service, as shown in example screen (b).

Referring to example screen (b), the display unit 120 may display an environment setting screen of the emergency situation alert service under control of the controller 190. Various selectable items are includable in the environment setting screen (b), such as a recording time 461, a decibel 462, a speech record 463, a receiver 464, automatic/manual 465, and SOS scheme 466. The recording time 461 is an item for setting a time unit (e.g., for 30 seconds) for recording sound when the current situation is deemed an emergency. If the 30 seconds unit is set, the controller 190 generates a recording file having a length of 30 seconds. The decibel item 462 determines the magnitude of a speech for determining that the current situation is an emergency. When a decibel of the received speech exceeds a preset decibel, for example, 90 dB, the controller 190 may determine that the current situation is emergent. The speech record item 463 is an item for generating the emergency situation pattern information 141. If the speech record 463 is selected, the controller 190 drives the microphone MIC and prompts the user to speak. The controller 190 detects speech characteristic information (e.g., tone, frequency, etc.) from the user's speech received by the MIC in response to the prompt and converted to speech data by the audio processor 160. Controller 190 stores the detected speech characteristic information in the memory 140 as at least one emergency situation pattern information 141.

The receiver item 464 is an item for designating at least one receiver to receive an alert of the emergency situation. Information of a designated receiver may include an e-mail and one or more phone numbers. When the user does not separately set a receiver, the receiver may be set to an emergency rescue center (e.g., “911”) set by a manufacturer. The automatic/manual item 465 is an item for setting whether the emergency situation alert service is automatically executed. For example, when the emergency situation alert service is automatically executed, the emergency situation alert service may be activated for a predetermined daily time interval, e.g., from midnight to 6 a.m. Here, the activation time may be set by the user. The SOS scheme item 466 is an item for setting an emergency situation alert service method in which an SOS message is sent in response to the emergent situation. For example, the user may set both an SOS message and a call connection to a designated party as an emergency situation alert service method. The SOS scheme 466 may be set by the manufacturer so that the user cannot change the recipients of the SOS message.

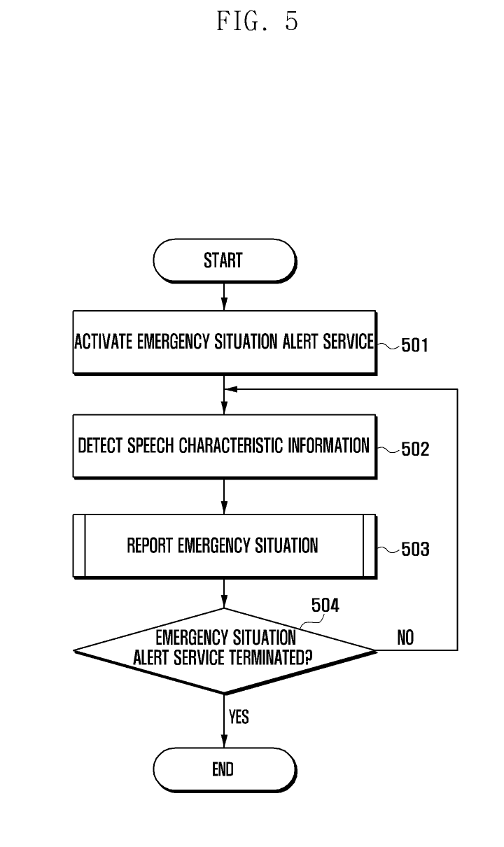

FIG. 5 is a flowchart illustrating a method of recognizing speech inputted from a microphone in a mobile terminal to provide an emergency situation alert service according to an exemplary embodiment of the present invention.

Referring to FIG. 5, if the user presses an emergency alert service on/off button 131 to activate the alert service, the controller 190 detects this input and activates the emergency situation alert service (501). That is, the controller 190 drives the MIC and the audio processor 160 (501) to a state ready to receive audio input. For example, the emergency situation alert service may be automatically activated at a preset time as described above (e.g., midnight). The audio processor 160 transfers speech data to the controller 190. The controller 190 detects speech characteristic information (e.g., tone, frequency, decibel, etc.) associated with characteristics of the speech from the received audio data (502). The controller 190 determines whether a current situation is emergent based on the detected speech characteristic information. When the current situation is emergent, the controller 190 controls the RF communication unit 150 to report an emergency situation to a preset external device (503). When the user selects termination of the emergency situation alert service, the controller 190 terminates the emergency situation alert service (504), and no longer performs the necessary speech recognition processing, etc. For example, the emergency situation alert service may be automatically terminated at a predefined time (e.g., 6 a.m.).

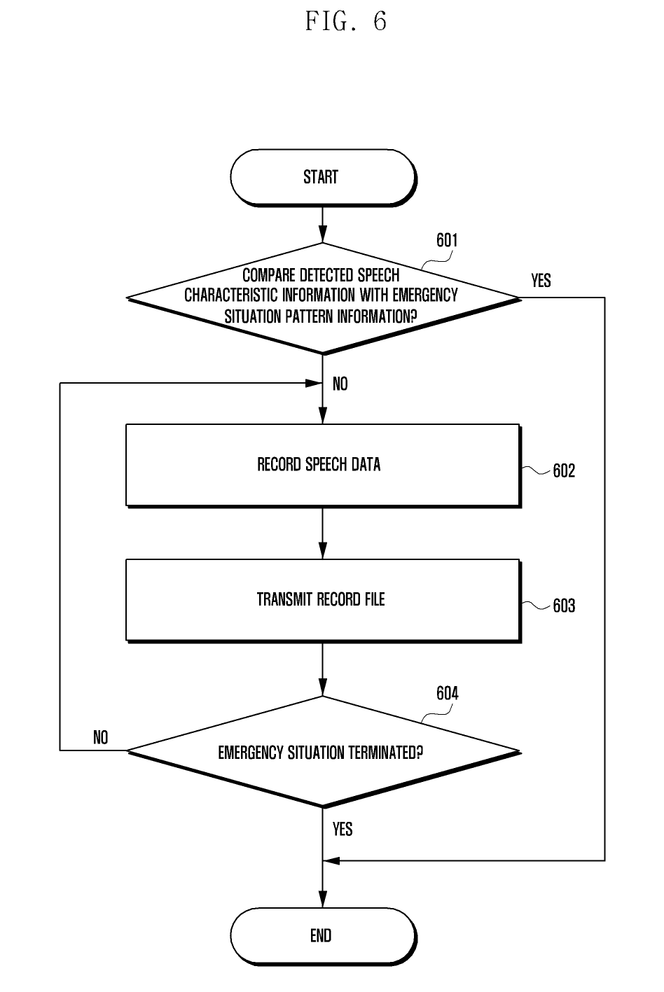

Various schemes may be employed for reporting the emergency at step 503. Several embodiments will be described with reference to FIGS. 6 to 9.

FIG. 6 is a flowchart illustrating a method of reporting an emergency situation to according to an exemplary embodiment of the present invention.

Referring to FIG. 6, the controller 190 compares the detected speech characteristic information with the emergency situation pattern information 141 to determine whether a current situation is emergent (601). For example, as mentioned earlier, in one option, the user may designate an emergent situation as one in which speech of a person other than at least one predetermined person is recognized. In this scenario, as a comparison result, frequency information and tone information thereof are different from that stored for the predetermined person(s). That is, the received speech is detected to be speech of a person other than a speech of a user registered in the mobile terminal 100.

When the detected speech characteristic information is different from the emergency situation pattern information, the controller 190 records speech data input from the audio processor 160 (602). For example, the recorded time unit may be three minutes. The time unit may be set by a manufacturer or a user. The controller 190 controls the RF communication unit 150 to transmit a record file to the external device (603). For example, the RF communication unit 150 may transmit the record file to the external device in the form of a Multimedia Messaging Service (MMS) message.

The controller 190 determines whether the emergency situation is terminated (604). For example, a ‘emergency situation termination’ button displayed on the touch screen is selected, the controller 190 terminates the emergency situation. That is, the controller 190 stops recording and transmission of the speech. When the ‘emergency situation termination’ button displayed on the touch screen is not selected, the controller 190 may repeat steps 602 and 603.

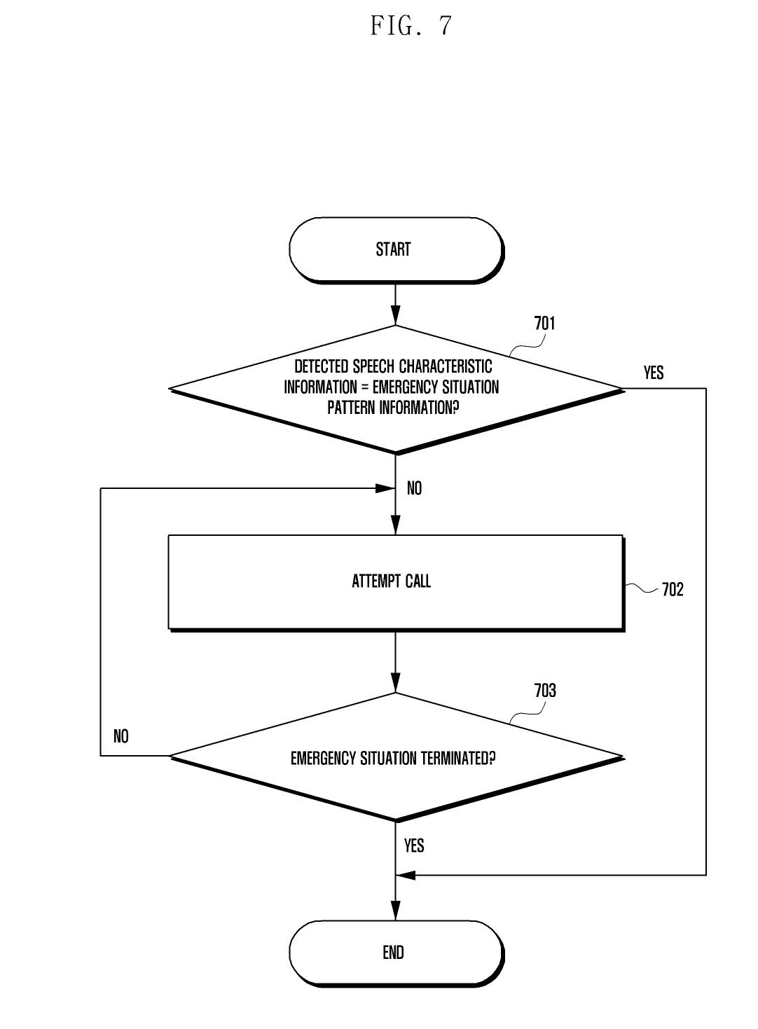

FIG. 7 is a flowchart illustrating a method of reporting an emergency situation alert according to another exemplary embodiment of the present invention. In this embodiment, an emergency situation is pre-designated to correspond to the detection of a non-registered voice, as in the embodiment of FIG. 6. Controller 190 first compares the detected speech characteristic information with the emergency situation pattern information 141 to determine whether the detected speech characteristic information matches the emergency situation pattern information 141 (701). For example, if frequency information and tone information thereof are different from each other, a mismatch is detected.

When a mismatch is detected, the controller 190 controls the RF communication unit 150 to transmit a signal for call connection to the external device so that a call (voice or video) with the external device is attempted (702). When call connection is achieved between two devices, the other party may recognize a situation of the user through a prepared speech message at the mobile terminal 100 retrieved from memory by controller 190, or through the received speech or video captured at the scene. The external device may be an emergency rescue center (e.g., a “911” center). The external device may be a terminal which the user separately sets. When the call connection is achieved between two devices, the controller 190 may be configured to not drive the speaker SPK. This option prevents speech from the other party from being leaked through the speaker SPK, thereby preventing a criminal from learning that others have been alerted. For the same reason, the controller 190 may avoid driving the display unit 120.

The controller 190 determines whether the emergency situation is terminated (703). For example, when the user presses a volume button of the key input unit 130, the controller 190 terminates an emergency situation and normally operates the mobile terminal 100 (for example, operates the speaker SPK and the display unit 120). When the emergency situation is not terminated, for example, when call connection with the external device is not achieved, the controller 190 may return to step 702 and again perform the call. If a key signal for terminating the emergency situation is not generated at step 703, the controller 190 may return to step 702 and again perform the call.

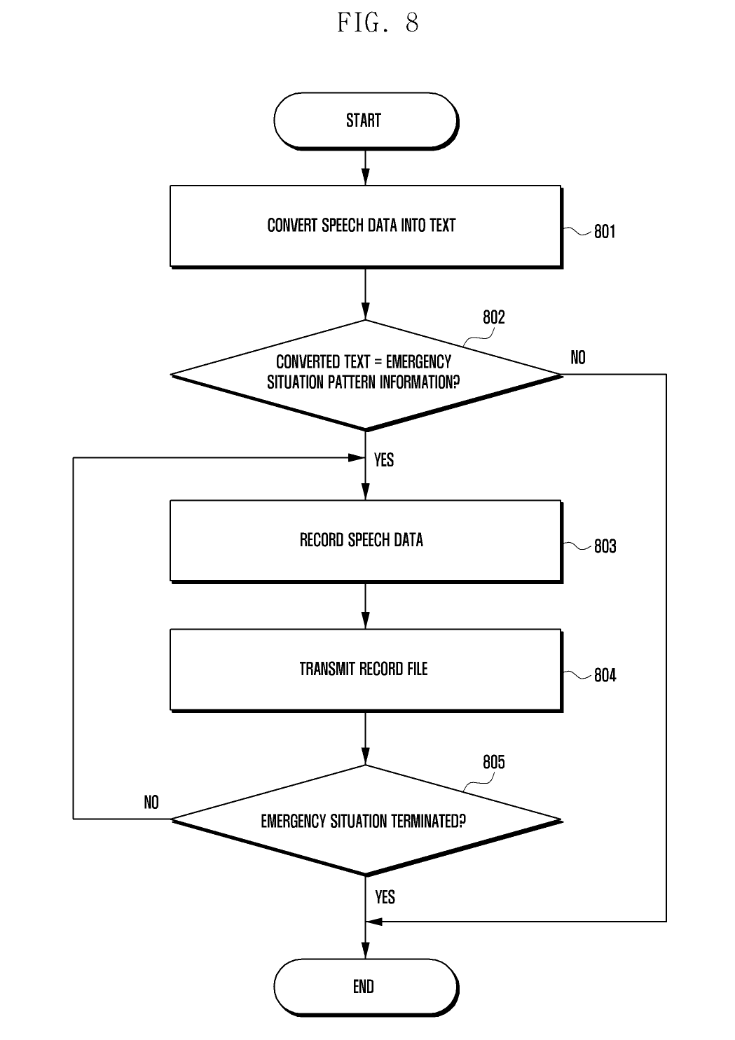

FIG. 8 is a flowchart illustrating a method of reporting an emergency situation alert according to still another exemplary embodiment of the present invention. In this embodiment, the controller 190 converts speech data received from the audio processor 160 into text (801). The controller 190 compares the converted text with the emergency situation pattern information 141, that is, character information to determine whether a current situation is emergent (802). When the converted text is the same as the emergency situation pattern information 141, the controller 190 determines that the current situation is emergent. For example, the converted text may be the word “help” uttered at least once. The controller 190 records the speech data input from the audio processor 160 in predetermined time units, e.g., three minutes (803). The recorded time unit may be set by a manufacturer or the user. It is noted, even though recording for the predetermined time duration of up to several minutes, a call to the external device alerting the other party of the emergency can be designed to occur immediately upon detection of the emergency via the speech recognition. That is, the emergency reporting call can be made well prior to expiration of the predetermined time period for recording.

The controller 190 controls the RF communication unit 150 to transmit a record file to an external device (804). For example, the RF communication unit 150 may transmit the record file to the external device in the form of an MMS message.

The controller 190 determines whether the emergency situation is terminated (805). For example, when a ‘emergency situation termination’ displayed on the touch screen is selected, the controller 190 terminates the emergency situation. That is, the controller 190 stops speech record and transmission. When a ‘emergency situation termination’ displayed on the touch screen is not selected, the controller 190 may repeatedly perform steps 803 and 804.

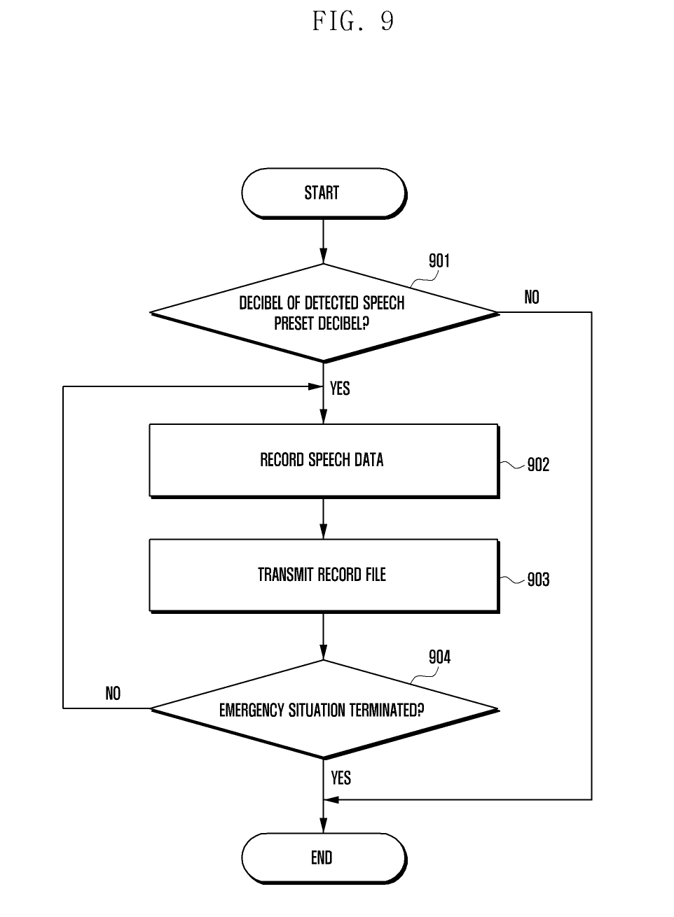

FIG. 9 is a flowchart illustrating a method of reporting an emergency situation alert according to yet another exemplary embodiment of the present invention.

The controller 190 determines whether a decibel of the detected speech is equal to or greater than a preset decibel (e.g., 90 dB) (901).

When the decibel of the detected speech is equal to or greater than 90 dB, the controller 190 records the speech data input from the audio processor 160, for example, for 3 minutes (902). The recorded time unit may be set by a manufacturer or a user. The controller 190 controls the RF communication unit 150 to transmit the record file to the external device (903). For example, the RF communication unit 150 may transmit the record file to the external device in the form of an MMS message.

The controller 190 determines whether the emergency situation is terminated (904). For example, when a ‘emergency situation terminated button displayed on the touch screen is selected, the controller 190 terminates the emergency situation. That is, the controller 190 stops the recording and transmission of the speech. When a ‘emergency situation terminated button displayed on the touch screen is not selected, the controller 190 may repeatedly perform steps 902 and 903.

The mobile terminal according to the embodiment of the present invention may include various types of devices supporting a speech recognition function. For example, the mobile terminal may be a smart phone, a Portable Multimedia Player (PMP), a digital broadcasting player, a Personal Digital Assistant (PDA), a music player (e.g., MP3 player), a portable game terminal, a tablet PC, or a Notebook PC.

Since the structural elements can be variously changed according to a convergence trend of a digital device, other elements are includable but not described herein. The mobile terminal according to the present invention may further include constituent elements which are not mentioned such as a Global Positioning System (GPS) receiving module. The configuration of the exemplary mobile terminal 100 of the present invention may be varied by alternative specific constructions in the foregoing arrangements.

According to the method of serving an emergency situation alert of the mobile terminal and an apparatus thereof according to embodiments of the present invention, an emergency situation of a user can be recognized using a speech recognition function included in a mobile terminal, and automatically reported to outside parties. In addition, the present invention may record the emergency situation and use the recorded data as evidence data with respect thereto.

The foregoing method for serving an emergency situation alert of the present invention may be implemented in an executable program command form by various computer means and be recorded in a computer readable recording medium. In this case, the computer readable recording medium may include a program command, a data file, and a data structure individually or a combination thereof. In the meantime, the program command recorded in a recording medium may be specially designed or configured for the present invention or be known to a person having ordinary skill in a computer software field to be used. The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as ROM. RAM, flash memory storing and executing program commands. Further, the program command ma include a machine language code created by a complier and a high-level language code executable by a computer using an interpreter. The foregoing hardware device may be configured to be operated as at least one software module to perform an operation of the present invention.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method operative in a mobile terminal having a speech recognition function, the method comprising:
recognizing speech received from a microphone;
determining whether a current situation is emergent based on the recognized speech; and
reporting an emergency situation via a radio frequency communication unit to a preset external device when the current situation is determined to be emergent.

2. The method of claim 1, wherein reporting the emergency situation comprises:
recording the speech received from the microphone; and
transmitting the recorded speech to the external device.

3. The method of claim 2, wherein the recording of the speech comprises recording the speech for a preset duration of time.

4. The method of claim 1, wherein reporting the emergency comprises transmitting a call connection signal for a call to the external device.

5. The method of claim 1, wherein the determining whether the current situation is emergent comprises:
comparing speech characteristic information in the recognized speech with stored emergency situation pattern information; and
determining that a current situation is emergent when the speech characteristic information in the recognition information is different from the stored emergency situation pattern information, wherein the different speech characteristic information is indicative of a non-registered person.

6. The method of claim 1, comprising:
comparing text information in the recognition information with stored emergency situation pattern information; and
determining that the current situation is emergent when the text information in the recognition information is substantially the same as the stored emergency situation pattern information.

7. The method of claim 1, further comprising determining that the current situation is emergent when a magnitude of the recognized speech is equal to or greater than a preset magnitude.

8. The method of claim 1, further comprising detecting input information for activating an emergency situation alert service,
wherein determining whether the current situation is emergent is performed in response to detection of the input information.

9. The method of claim 1, wherein determining whether the current situation is emergent is automatically performed when a preset time arrives.

10. A mobile terminal comprising:
a microphone;
an audio processor converting speech input from the microphone into speech data;
a radio frequency communication unit transmitting information associated with the speech data to an external device; and
a controller recognizing the speech data from the audio processor, determining whether a current situation is emergent based on the speech recognition, and controlling the radio frequency unit to report an emergency situation to the external device when the current situation is determined to be emergent.

11. The mobile terminal of claim 10, wherein when the current situation is emergent, the controller records the speech data from the audio processor, and controls the radio frequency communication unit to transmit the recorded speech data to the external device.

12. The mobile terminal of claim 10, wherein when the current situation is emergent, the controller controls the radio frequency communication unit to transmit a call connection signal for a call with the external device.

13. The mobile terminal of claim 11, wherein when the current situation is emergent, the controller controls the radio frequency communication unit to transmit a call connection signal for a call with the external device while the speech data is being recorded.

14. The mobile terminal of claim 10, wherein the controller compares speech characteristic information in the recognition information with a stored emergency pattern information, and determines a current state as an emergency situation when the speech characteristic information in the recognition information is different from the stored emergency pattern information, wherein the different speech characteristic information is indicative of the presence of a non-registered person.

15. The mobile terminal of claim 10, wherein the controller compares text information in the recognition with stored emergency situation pattern information, and determines a current situation as an emergency situation when the text information in the recognition is the same as the stored emergency situation pattern information.

16. The mobile terminal of claim 10, wherein when magnitude of a speech in the recognition information equals or exceeds a preset magnitude, the controller determines the current situation as the emergency situation.
